(19) United States
(12) Patent Application Publication
(10) Pub. No.: US 2026/0131651 A1
(43) Pub. Date: May 14, 2026

(54) Windshield Safety Assist Device

(71) Applicant: Kriston Sanders, Pensacola, FL (US)

(72) Inventor: Kriston Sanders, Pensacola, FL (US)

(21) Appl. No.: 19/266,640

(22) Filed: Jul. 11, 2025

Related U.S. Application Data
(60) Provisional application No. 63/719,140, filed on Nov. 12, 2024.

(51) Int. Cl. B60K 35/231; B60J 3/00; B60J 3/04; B60W 10/30

(52) U.S. Cl. CPC B60K 35/231; B60J 3/007; B60J 3/04; B60W 10/30; B60W 2510/06; B60W 2555/20

(57) ABSTRACT

A windshield safety assist device is disclosed, which is a standard windshield for vehicles with built-in safety capabilities, which can be controlled automatically or by a user. The windshield safety assist device comprises the following safety capabilities, but is not limited to, glass tinting, glare control, lane assist, and blind spot warnings, etc. The device comprises user controls which will allow the user to manually control the safety capabilities. Further, the device projects a heads-up display with lane assist and blind spot warnings. Additionally, the device can automatically tint the windshield when the vehicle is off to protect the interior from sun damage.

### CROSS-REFERENCE TO RELATED APPLICATION

The present application claims priority to, and the benefit of, U.S. Provisional Application No. 63/719,140, which was filed on Nov. 12, 2024, and is incorporated herein by reference in its entirety.

### FIELD OF THE INVENTION

The present invention relates generally to the field of windshield safety assist devices. More specifically, the present invention relates to a device for a vehicle that includes glare control, which is controlled either automatically or manually. Accordingly, this disclosure makes specific reference thereto the present invention. Nonetheless, it is to be appreciated that aspects of the present invention are also equally applicable to other like applications, devices and methods of manufacture.

### BACKGROUND

By way of background, this invention relates to improvements in windshield safety assist devices. Generally, poor driving conditions including weather or another vehicle's headlights can impair visibility and lead to potential accidents. These driving conditions can be dangerous not only to drivers, but also to pedestrians. Further, even the best drivers encounter poor driving conditions that can impair visibility on the road and potentially lead to dangerous accidents.

Additionally, most vehicles are fitted with permanent tinted glass for use as windows or rear shields to reduce the amount of light in the passenger cabin. Large amounts of light incident within a passenger cabin can make it difficult for a driver to view the instrument panel or see out of the vehicle in the direction of the light source. However, the tinted glass can be insufficient for visibility while driving in direct sun, which may impair visibility.

Accordingly, there is a demand for an improved windshield safety assist device that can be controlled automatically or manually. More particularly, there is a demand for a windshield safety assist device that provides glare control, glass tinting, lane assist, and blind spot warnings, as needed.

Therefore, there exists a long felt need in the art for a windshield safety assist device that provides users with a standard windshield for vehicles with built-in safety capabilities. There is also a long felt need in the art for a windshield safety assist device that provides for glass tinting, glare control, lane assist, and blind spot warnings. Further, there is a long felt need in the art for a windshield safety assist device that includes user controls which will allow the user to manually control the safety capabilities. Moreover, there is a long felt need in the art for a device that will automatically tint the windshield when the vehicle is off to protect the interior from sun damage. Further, there is a long felt need in the art for a windshield safety assist device that increase safety by placing the warning lights directly in the user's line of sight. Finally, there is a long felt need in the art for a windshield safety assist device that includes electrochromic sun and headlight tracking for selective tinting while driving.

The subject matter disclosed and claimed herein, in one embodiment thereof, comprises a windshield safety assist device. The device is a standard windshield for vehicles with built-in safety capabilities, which can be controlled automatically or by a user. The windshield safety assist device comprises the following safety capabilities, but is not limited to, glass tinting, glare control, lane assist, and blind spot warnings, etc. The device comprises user controls which will allow the user to manually control the safety capabilities. Further, the device projects a heads-up display with lane assist and blind spot warnings. Additionally, the device can automatically tint the windshield when the vehicle is off to protect the interior from sun damage.

In this manner, the windshield safety assist device of the present invention accomplishes all of the forgoing objectives and provides users with a standard windshield for vehicles with built-in safety capabilities. The device increases safety for a vehicle and driver. The safety capabilities can be automatic or manual.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a windshield safety assist device. The device is a standard windshield for vehicles with built-in safety capabilities, which can be controlled automatically or manually by a user. The windshield safety assist device comprises the following safety capabilities, but is not limited to, glass tinting, glare control, lane assist, and blind spot warnings, etc.

In one embodiment, the windshield safety assist device provides increased safety on the road with non-obtrusive peripheral visual cues, automatic selective tinting of glare hazards, including sun and headlights, and full windshield tinting when parked for improved heat control inside the vehicle. The device comprises a range of driver assist technologies, including automatic electrochromic glass tinting, glare control during travel, and a heads-up display with lane assist and blind spot warnings. Accordingly, the windshield safety assist device includes attention and safety-enhancing driver assist technology, which is designed to improve visibility for drivers.

Solar energy incident on the vehicle may be reflected or absorbed by the vehicle. Solar energy incident on a vehicle window of a vehicle radiates through the window and is absorbed by the inside of the vehicle causing the vehicle cabin to rise in temperature. Generally, air is trapped inside the vehicle when the vehicle is not in operation or the vehicle windows are not open. Therefore, the solar energy absorbed by the interior of the vehicle increases the temperature of the vehicle cabin. A vehicle window with a tint applied reduces the amount of solar energy that radiates through the vehicle window and is absorbed by the interior. Accordingly, the amount of window tint decreases the rate at which the temperature inside the vehicle increases because less solar energy radiates through a vehicle window.

In one embodiment, the windshield safety assist device is utilized with a vehicle having a selectively transparent windshield and selectively transparent windows. The selectively transparent windshield is in communication with a controller. The controller adjusts the light transmissivity of the selectively transparent windshield in response to input from manual controls or automatically through responses communicated from sensors. The sensors and manual controls are communicatively coupled to the controller. The controller processes the information using a processing unit that executes instructions stored in a memory.

In one embodiment, the selectively transparent windshield or selectively transparent windows may be formed from any medium capable of transitioning between various states of light transmissivity in response to a control signal. For example, the windshield and windows can comprise a photosensitive film, which reacts automatically to direct sunlight. In another embodiment, the windshield comprises, without limitation, a liquid crystal display, a polymer-dispersed liquid crystal film, an electrochromic material or film, etc. Thus, the selectively transparent windshield may be a film applied to a surface of a vehicle windshield, a layer interleaved in a vehicle windshield or may operate as the vehicle windshield standing alone.

In one embodiment, the controller may be any device or combination of components comprising a processing unit and a memory. The processing unit may be an integrated circuit, a microchip, a computer, or any other computing device for executing instructions from the memory. Further, the controller and components may be housed within the vehicle bus of the vehicle.

In one embodiment, the windshield safety assist device is operable by manual input from the user. Prompts may be generated on a tactile display within the vehicle providing for feedback from the user. The user can then manually control the windshield tinting via inputting whether to not tint or to tint the windshield of the vehicle. Further, the vehicle can also have designated onscreen buttons (or buttons on the dash or console) that the user can press to control the tinting, as desired. By selecting an onscreen button or other input component, a signal is transmitted to the controller which controls whether the windshield is tinted or not. Thus, the windshield safety assist device provides simple user controls for tint level and auto mode.

In one embodiment, the windshield safety assist device is an automatic event that is controlled via sensors on the vehicle, which are in communication with the controller. The sensors detect and transmit information received from the sensors to the controller. The controller processes the information using a processing unit that executes instructions stored in a memory to automatically tint the windshield.

In one embodiment, one of the sensors comprise an ignition sensor. The ignition sensor determines whether the vehicle has been shut off or not. Once the ignition sensor detects that the vehicle is turned off, the windshield safety assist device is activated to automatically tint the windshield and windows of the vehicle. Thus, when the vehicle is off, the electrochromic windshield is automatically activated to a full windshield tint to keep the interior of the vehicle cool. Thus, protecting the interior finishes and the dashboard of a vehicle from sun damage.

In one embodiment, one of the sensors comprise at least one temperature sensor positioned within an interior of the vehicle. The at least one temperature sensor detects the temperature of the interior of the vehicle. The temperature sensor can be a thermocouple, a resistive temperature device, an infrared sensor, etc. Once the temperature reaches a certain temperature within the vehicle the windshield safety assist device can be activated to automatically tint the windshield and windows.

In one embodiment, one of the sensors is a light sensor which can be positioned near the windshield or vehicle dash, exterior or interior of the vehicle. The light sensor is any sensor capable of generating a light sensor signal indicative of the presence of light, such as a photodiode, a phototube, etc. Information from the light sensors is then communicated to the controller for activating the windshield safety assist device to automatically tint the windshield. For example, the light sensor can provide electrochromic sun-tracking to determine when to automatically tint the windshield and to what degree in which to tint the windshield. Thus, the light sensor can determine whether it is day or night, and how sunlight is affecting the visibility of the driver. In another embodiment, the light sensor determines if another vehicle's headlights are impeding the visibility of the driver. Thus, the light sensor provides electrochromic headlight-tracking to determine when to automatically tint the windshield and to what degree in which to tint the windshield. Thus, the windshield safety assist device provides tint control and glare control, as needed. The electrochromic sun and headlight tracking provides selective tinting while driving.

In one embodiment, the degree of automatic tinting is determined based on the light sensor signal indicating the intensity level of the sun and/or headlights on the vehicle. For example, on a cloudy day when the light intensity is not as great as the light intensity on a cloudless sunny day, the automatic tinting would be less on a cloudy day as compared to a cloudless sunny day. Specifically, the controller monitors the signals from the communicatively coupled sensors, i.e., the light sensor, the temperature sensor, the ignition sensor, etc., and any other suitable sensors that are needed. As the controller receives signals from the communicatively coupled sensors, the processing unit executes the stored instructions from the memory to generate control signals for automatically tinting the windshield in response to the received signals.

In one embodiment, the windshield safety assist device provides a heads-up display with lane assist and blind spot warnings. The device would greatly increase safety as it would place the warning lights directly in the user's line of sight. The heads-up display can encompass any suitable symbols or alerts to alert the driver of vehicles in nearby lanes and/or blind spots. In this embodiment, proximate sensors can be utilized to determine nearby vehicles or other suitable sensors as is known in the art.

In yet another embodiment, the windshield safety assist device comprises a plurality of indicia.

In yet another embodiment, a method of increasing safety while driving is disclosed. The method includes the steps of providing a windshield safety assist device comprising a plurality of safety capabilities. The method also comprises providing for a heads-up display for lane assist and blind spot warnings. The method includes providing electrochromic full tinting when the vehicle is off. Further, the method comprises providing electrochromic sun-tracking selective tinting. The method also comprises providing electrochromic headlight-tracking selective tinting. Finally, the method comprises providing manual control of the safety capabilities.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the windshield safety assist device of the present invention in accordance with the disclosed architecture;

FIG. 2 illustrates a perspective view of one embodiment of the windshield safety assist device of the present invention showing the windows automatically tinting when the vehicle is off to protect the interior from sun damage in accordance with the disclosed architecture;

FIG. 3 illustrates a perspective view of one embodiment of the windshield safety assist device of the present invention showing the windows being tinted for glare control in accordance with the disclosed architecture;

FIG. 4 illustrates a perspective view of one embodiment of the windshield safety assist device of the present invention showing the windows being tinted to prevent glare from other vehicle headlights in accordance with the disclosed architecture;

FIG. 5 illustrates a perspective view of one embodiment of the windshield safety assist device of the present invention showing the heads-up display in accordance with the disclosed architecture;

FIG. 6 illustrates a perspective view of one embodiment of the windshield safety assist device of the present invention showing the heads-up display with lane assist in accordance with the disclosed architecture;

FIGS. 7A-C illustrate a perspective view of one embodiment of the windshield safety assist device of the present invention and its components in accordance with the disclosed architecture;

FIGS. 8A-B illustrate a perspective view of one embodiment of the windshield safety assist device of the present invention in use in accordance with the disclosed architecture; and

FIG. 9 illustrates a flowchart showing the method of increasing safety while driving in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a windshield safety assist device that provides users with a standard windshield for vehicles with built-in safety capabilities. There is also a long felt need in the art for a windshield safety assist device that provides for glass tinting, glare control, lane assist, and blind spot warnings. Further, there is a long felt need in the art for a windshield safety assist device that includes user controls which will allow the user to manually control the safety capabilities. Moreover, there is a long felt need in the art for a device that will automatically tint the windshield when the vehicle is off to protect the interior from sun damage. Further, there is a long felt need in the art for a windshield safety assist device that increase safety by placing the warning lights directly in the user's line of sight. Finally, there is a long felt need in the art for a windshield safety assist device that includes electrochromic sun and headlight tracking for selective tinting while driving.

The present invention, in one exemplary embodiment, is a novel windshield safety assist device. The device is a standard windshield for vehicles with built-in safety capabilities, which can be controlled automatically or by a user. The windshield safety assist device comprises the following safety capabilities, but is not limited to, glass tinting, glare control, lane assist, and blind spot warnings, etc. The device comprises user controls which will allow the user to manually control the safety capabilities. The present invention also includes a novel method of increasing safety while driving. The method includes the steps of providing a windshield safety assist device comprising a plurality of safety capabilities. The method also comprises providing for a heads-up display for lane assist and blind spot warnings. The method includes providing electrochromic full tinting when the vehicle is off. Further, the method comprises providing electrochromic sun-tracking selective tinting. The method also comprises providing electrochromic headlight-tracking selective tinting. Finally, the method comprises providing manual control of the safety capabilities.

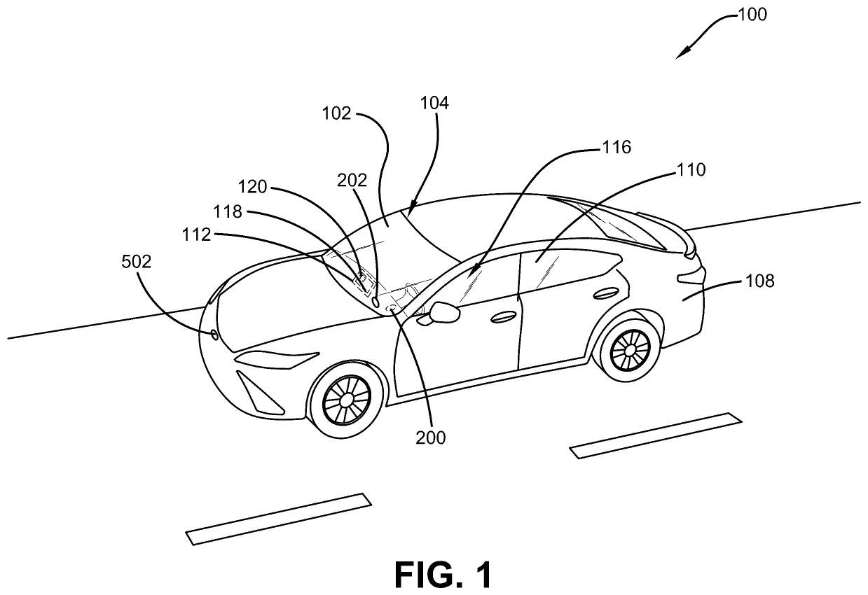

Referring initially to the drawings, FIG. 1 illustrates a perspective view of one embodiment of the windshield safety assist device 100 of the present invention. In the present embodiment, the windshield safety assist device 100 is an improved windshield safety assist device 100 that provides a user 106 with a means for increasing safety while driving. Specifically, the windshield safety assist device 100 comprises a windshield 102 with a plurality of safety capabilities 104, which can be controlled automatically or manually by a user 106. The windshield safety assist device 100 comprises the following safety capabilities 104, but is not limited to, glass tinting, glare control, lane assist, and blind spot warnings, etc.

Generally, the windshield safety assist device 100 provides increased safety on the road with non-obtrusive peripheral visual cues, automatic selective tinting of glare hazards, including sun and headlights, and full windshield tinting when parked for improved heat control inside the vehicle 108. The device 100 comprises a range of driver assist technologies, including automatic electrochromic glass tinting, glare control during travel, and a heads-up display with lane assist and blind spot warnings. Accordingly, the windshield safety assist device 100 includes attention and safety-enhancing driver assist technology, which is designed to improve visibility for drivers.

Solar energy incident on the vehicle 108 may be reflected or absorbed by the vehicle 108. Solar energy incident on a vehicle window of a vehicle 108 radiates through the window and is absorbed by the inside of the vehicle 108 causing the vehicle cabin to rise in temperature. Generally, air is trapped inside the vehicle 108 when the vehicle 108 is not in operation or the vehicle windows are not open. Therefore, the solar energy absorbed by the interior of the vehicle 108 increases the temperature of the vehicle cabin. A vehicle window with a tint applied reduces the amount of solar energy that radiates through the vehicle window and is absorbed by the interior. Accordingly, the amount of window tint decreases the rate at which the temperature inside the vehicle 108 increases because less solar energy radiates through a vehicle window.

Further, the windshield safety assist device 100 is utilized with a vehicle 108 having a selectively transparent windshield 102 and selectively transparent windows 110. The selectively transparent windshield 102 is in communication with a controller 112. The controller 112 adjusts the light transmissivity of the selectively transparent windshield 102 in response to input from manual controls 114 or automatically through responses communicated from sensors 116. The sensors 116 and manual controls 114 are communicatively coupled to the controller 112. The controller 112 processes the information using a processing unit 118 that executes instructions stored in a memory 120.

Additionally, the selectively transparent windshield 102 or selectively transparent windows 110 may be formed from any medium capable of transitioning between various states of light transmissivity in response to a control signal. For example, the windshield 102 and windows 110 can comprise a photosensitive film, which reacts automatically to direct sunlight. In another embodiment, the windshield 102 comprises, without limitation, a liquid crystal display, a polymer-dispersed liquid crystal film, an electrochromic material or film, etc. Thus, the selectively transparent windshield 102 may be a film applied to a surface of a vehicle windshield 102, a layer interleaved in a vehicle windshield 102 or may operate as the vehicle windshield 102 standing alone.

Furthermore, the controller 112 may be any device or combination of components comprising a processing unit 118 and a memory 120. The processing unit 118 may be an integrated circuit, a microchip, a computer, or any other computing device for executing instructions from the memory 120. Further, the controller 112 and components may be housed within the vehicle bus of the vehicle 108.

Further, the windshield safety assist device 100 is operable by manual input from the user 106. Prompts may be generated on a tactile display within the vehicle 108 providing for feedback from the user 106. The user 106 can then manually control the windshield tinting via inputting whether to not tint or to tint the windshield 102 of the vehicle 108. Further, the vehicle 108 can also have designated onscreen buttons 122 (or buttons on the dash 124 or console) that the user 106 can press to control the tinting, as desired. By selecting an onscreen button 122 or other input component, a signal is transmitted to the controller 112 which controls whether the windshield 102 is tinted or not. Thus, the windshield safety assist device 100 provides simple user controls for tint level and auto mode.

Additionally, the windshield safety assist device 100 is an automatic event that is controlled via sensors 116 on the vehicle 108, which are in communication with the controller 112. The sensors 116 detect and transmit information received from the sensors 116 to the controller 112. The controller 112 processes the information using a processing unit 118 that executes instructions stored in a memory 120 to automatically tint the windshield 102.

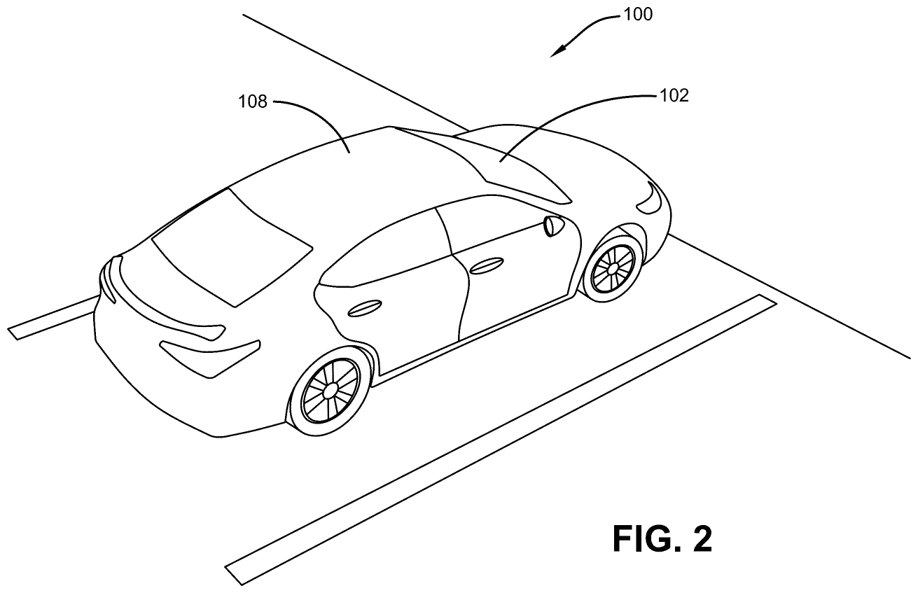

As shown in FIG. 2, one of the sensors 116 comprise an ignition sensor 200. The ignition sensor 200 determines whether the vehicle 108 has been shut off or not. Once the ignition sensor 200 detects that the vehicle 108 is turned off, the windshield safety assist device 100 is activated to automatically tint the windshield 102 and windows 110 of the vehicle 108. Thus, when the vehicle 108 is off, the electrochromic windshield 102 is automatically activated to a full windshield tint to keep the interior of the vehicle 108 cool. Thus, protecting the interior finishes and the dashboard 124 of a vehicle 108 from sun damage.

Further, one of the sensors 116 comprise at least one temperature sensor 202 positioned within an interior of the vehicle 108. The at least one temperature sensor 202 detects the temperature of the interior of the vehicle 108. The temperature sensor 202 can be a thermocouple, a resistive temperature device, an infrared sensor, etc. Once the temperature reaches a certain temperature within the vehicle 108 the windshield safety assist device 100 can be activated to automatically tint the windshield 102 and windows 110.

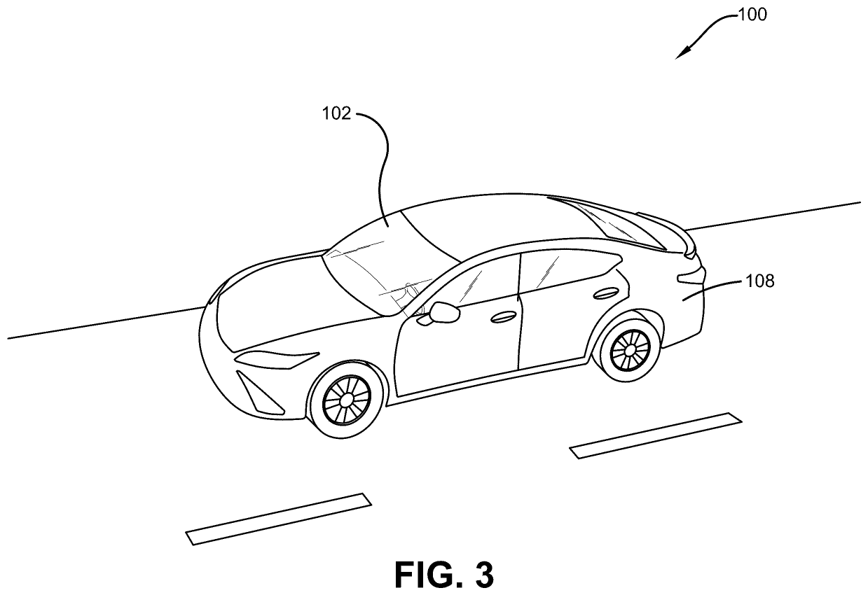

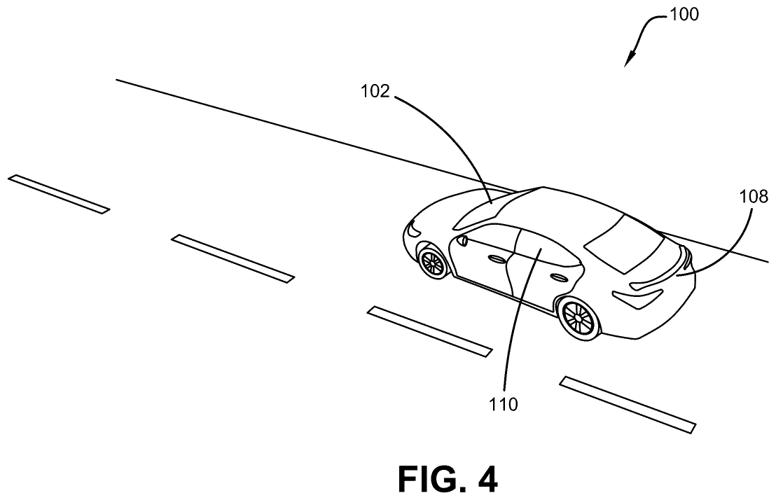

As shown in FIGS. 3-4, one of the sensors 116 is a light sensor 300 which can be positioned near the windshield 102 or vehicle dash 124, exterior or interior of the vehicle 108. The light sensor 300 is any sensor capable of generating a light sensor signal indicative of the presence of light, such as a photodiode, a phototube, etc. Information from the light sensors 300 is then communicated to the controller 112 for activating the windshield safety assist device 100 to automatically tint the windshield 102. For example, the light sensor 300 can provide electrochromic sun-tracking to determine when to automatically tint the windshield 102 and to what degree in which to tint the windshield 102. Thus, the light sensor 300 can determine whether it is day or night, and how sunlight is affecting the visibility of the driver. In another embodiment, the light sensor 300 determines if another vehicle's headlights are impeding the visibility of the driver. Thus, the light sensor 300 provides electrochromic headlight-tracking to determine when to automatically tint the windshield 102 and to what degree in which to tint the windshield 102. Thus, the windshield safety assist device 100 provides tint control and glare control, as needed. The electrochromic sun and headlight tracking provides selective tinting while driving.

Further, the degree of automatic tinting is determined based on the light sensor 300 signal indicating the intensity level of the sun and/or headlights on the vehicle 108. For example, on a cloudy day when the light intensity is not as great as the light intensity on a cloudless sunny day, the automatic tinting would be less on a cloudy day as compared to a cloudless sunny day. Specifically, the controller 112 monitors the signals from the communicatively coupled sensors 116, i.e., the light sensor 300, the temperature sensor 202, the ignition sensor 200, etc., and any other suitable sensors that are needed. As the controller 112 receives signals from the communicatively coupled sensors 116, the processing unit 118 executes the stored instructions from the memory 120 to generate control signals for automatically tinting the windshield 102 in response to the received signals.

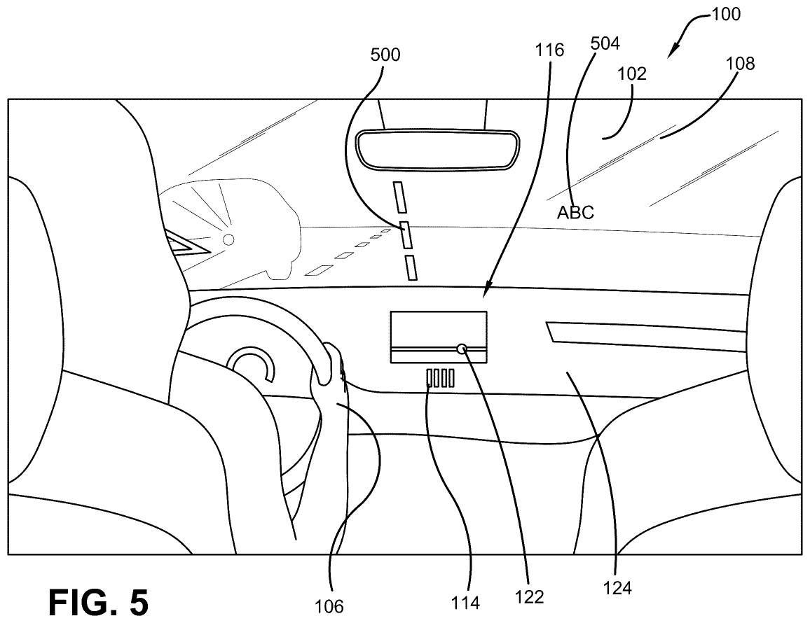

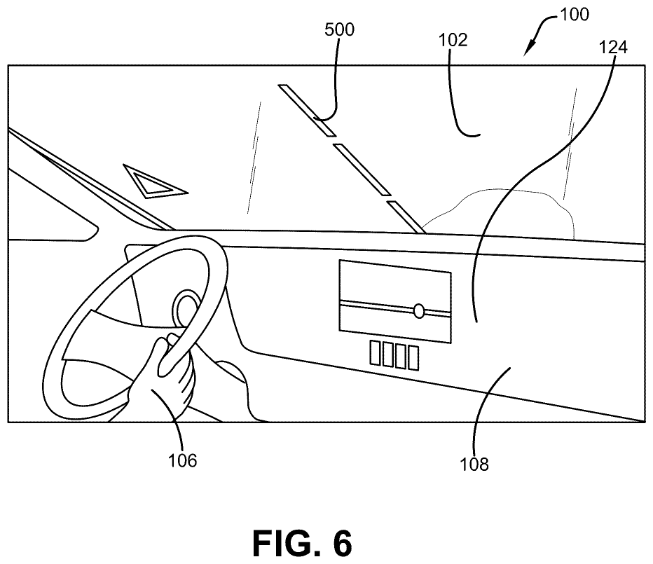

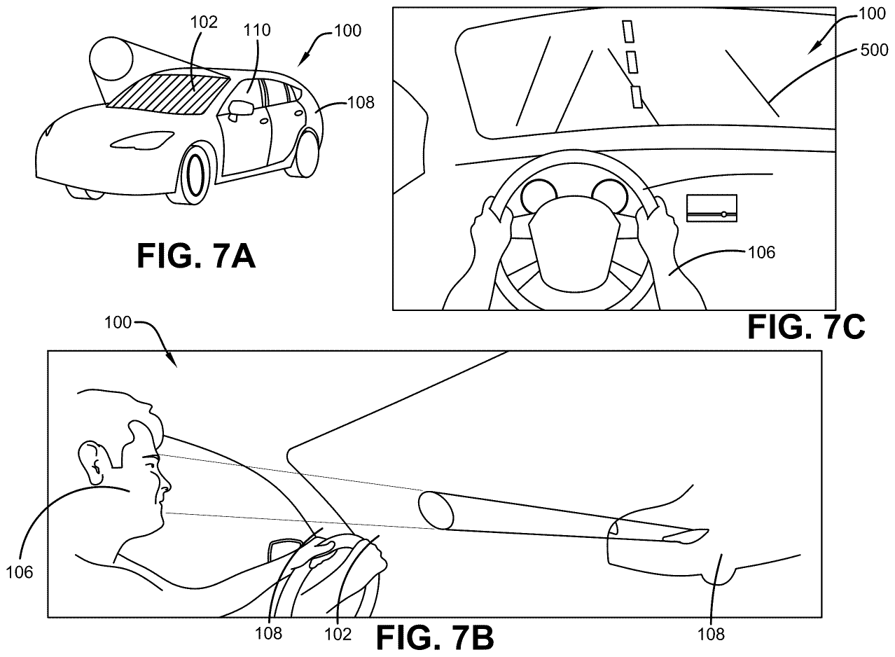

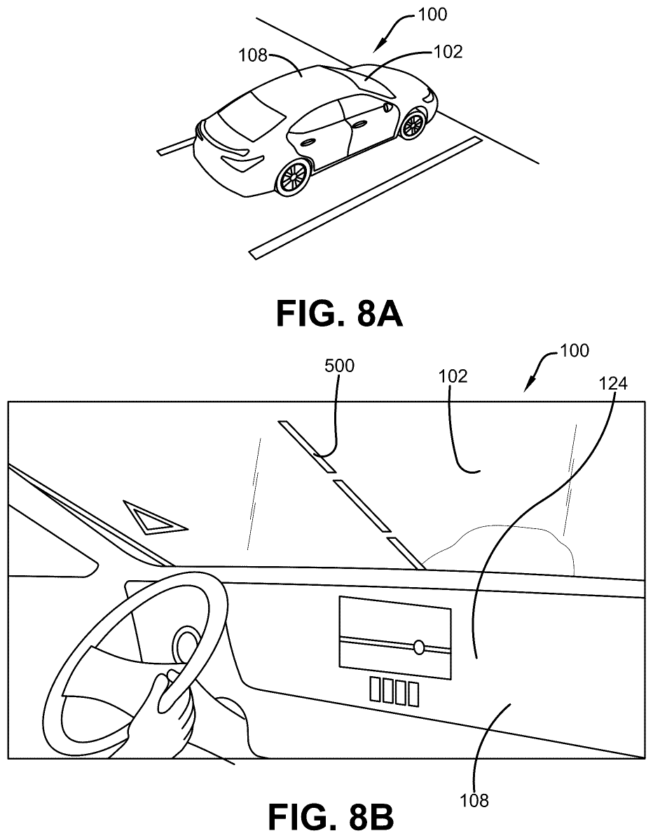

As shown in FIGS. 5-8, the windshield safety assist device 100 provides a heads-up display 500 with lane assist and blind spot warnings. The device 100 would greatly increase safety as it would place the warning lights directly in the user's line of sight. The heads-up display 500 can encompass any suitable symbols or alerts to alert the driver of vehicles 108 in nearby lanes and/or blind spots. In this embodiment, proximate sensors 502 can be utilized to determine nearby vehicles 108 or other suitable sensors as is known in the art.

In yet another embodiment, the windshield safety assist device 100 comprises a plurality of indicia 504. The windshield 102 of the device 100 may include advertising, a trademark, or other letters, designs, or characters, printed, painted, stamped, or integrated into the windshield 102, or any other indicia 504 as is known in the art. Specifically, any suitable indicia 504 as is known in the art can be included, such as but not limited to, patterns, logos, emblems, images, symbols, designs, letters, words, characters, animals, advertisements, brands, etc., that may or may not be vehicle, sunlight, or brand related.

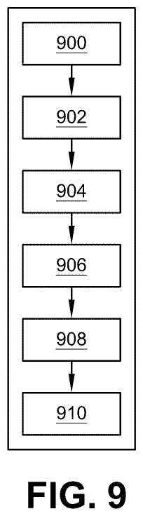

FIG. 9 illustrates a flowchart of the method of increasing safety while driving. The method includes the steps of at 900, providing a windshield safety assist device comprising a plurality of safety capabilities. The method also comprises at 902, providing for a heads-up display for lane assist and blind spot warnings. The method includes at 904, providing electrochromic full tinting when the vehicle is off. Further, the method comprises at 906, providing electrochromic sun-tracking selective tinting. The method also comprises at 908, providing electrochromic headlight-tracking selective tinting. Finally, the method comprises at 910, providing manual control of the safety capabilities.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “windshield safety assist device”, “safety assist device”, “windshield device”, and “device” are interchangeable and refer to the windshield safety assist device 100 of the present invention.

Notwithstanding the forgoing, the windshield safety assist device 100 of the present invention can be of any suitable size and configuration as is known in the art without affecting the overall concept of the invention, provided that it accomplishes the above stated objectives. One of ordinary skill in the art will appreciate that the windshield safety assist device 100 as shown in FIGS. 1-9 is for illustrative purposes only, and that many other sizes and shapes of the windshield safety assist device 100 are well within the scope of the present disclosure. Although the dimensions of the windshield safety assist device 100 are important design parameters for user convenience, the windshield safety assist device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A windshield safety assist device that provides safety on the road, the windshield safety assist device comprising:
a windshield; and
a plurality of safety capabilities;
wherein the plurality of safety capabilities are incorporated into the windshield of a vehicle;
wherein the plurality of safety capabilities can be controlled automatically or manually by a user; and
further wherein the plurality of safety capabilities include but are not limited to, glass tinting, glare control, lane assist, and blind spot warnings.

2. The windshield safety assist device of claim 1, wherein the windshield is a selectively transparent windshield that is in communication with a controller.

3. The windshield safety assist device of claim 2, wherein the controller adjusts light transmissivity of the selectively transparent windshield in response to input from manual controls or automatically through responses communicated from sensors.

4. The windshield safety assist device of claim 3, wherein the sensors and the manual controls are communicatively coupled to the controller, and the controller processes information using a processing unit that executes instructions stored in a memory.

5. The windshield safety assist device of claim 4, wherein the selectively transparent windshield comprises an electrochromic material or film.

6. The windshield safety assist device of claim 5, wherein the windshield safety assist device is operable by manual input from the user via designated onscreen buttons on a dashboard of the vehicle.

7. The windshield safety assist device of claim 6 further comprising an ignition sensor that determines whether the vehicle has been shut off or not, and once the ignition sensor detects that the vehicle is turned off, the windshield safety assist device is activated to automatically tint the selectively transparent windshield to keep interior of the vehicle cool.

8. The windshield safety assist device of claim 7 further comprising at least one temperature sensor positioned within an interior of the vehicle to detect temperature of the interior of the vehicle to activate automatic tint of the selectively transparent windshield.

9. The windshield safety assist device of claim 8 further comprising a light sensor positioned within the vehicle to provide headlight-tracking and sun-tracking to determine when to automatically tint the selectively transparent windshield and to what degree in which to tint the selectively transparent windshield.

10. The windshield safety assist device of claim 9 further comprising a heads-up display with lane assist and blind spot warnings.

11. The windshield safety assist device of claim 10 further comprising a proximate sensor to determine nearby vehicles.

12. The windshield safety assist device of claim 11 further comprising a plurality of indicia.

13. A windshield safety assist device that provides safety on the road, the windshield safety assist device comprising:
a selectively transparent windshield; and
a plurality of safety capabilities;
wherein the plurality of safety capabilities are incorporated into the windshield of a vehicle;
wherein the plurality of safety capabilities include but are not limited to, glass tinting, glare control, lane assist, and blind spot warnings;
wherein the selectively transparent windshield is in communication with a controller;
wherein the controller adjusts light transmissivity of the selectively transparent windshield in response to input from manual controls or automatically through responses communicated from sensors;
wherein the sensors and the manual controls are communicatively coupled to the controller, and the controller processes information using a processing unit that executes instructions stored in a memory; and
further wherein the selectively transparent windshield provides a heads-up display with lane assist and blind spot warnings.

14. The windshield safety assist device of claim 13, wherein the selectively transparent windshield comprises an electrochromic material or film.

15. The windshield safety assist device of claim 13, wherein the windshield safety assist device is operable by manual input from the user via designated onscreen buttons on a dashboard of the vehicle.

16. The windshield safety assist device of claim 13 further comprising an ignition sensor that determines whether the vehicle has been shut off or not.

17. The windshield safety assist device of claim 16, wherein once the ignition sensor detects that the vehicle is turned off, the windshield safety assist device is activated to automatically tint the selectively transparent windshield to keep interior of the vehicle cool.

18. The windshield safety assist device of claim 13 further comprising a light sensor positioned within the vehicle to provide headlight-tracking and sun-tracking to determine when to automatically tint the selectively transparent windshield and to what degree in which to tint the selectively transparent windshield.

19. The windshield safety assist device of claim 13 further comprising a proximate sensor to determine nearby vehicles for the heads-up display.

20. A method of increasing safety while driving, the method comprising the following steps:
providing a windshield safety assist device comprising a plurality of safety capabilities;
providing for a heads-up display for lane assist and blind spot warnings;
providing electrochromic full tinting when the vehicle is off;
providing electrochromic sun-tracking selective tinting;
providing electrochromic headlight-tracking selective tinting; and
providing manual control of the safety capabilities.
